(19) United States
(12) Patent Application Publication
(10) Pub. No.: US 2015/0310767 A1
(43) Pub. Date: Oct. 29, 2015

(54) Wireless Typoscope

(71) Applicant: OmniVision Technologies, Inc., Santa Clara, CA (US)

(72) Inventors: Raymond WU, Milpites, CA (US); Wei-Feng Huang, Saratoga, CA (US); Tawei Ho, Cupertino, CA (US)

(73) Assignee: OmniVision Technologies, Inc.

(21) Appl. No.: 14/680,615

(22) Filed: Apr. 7, 2015

Related U.S. Application Data
(60) Provisional application No. 61/983,670, filed on Apr. 24, 2014.

(51) Int. Cl. G09B 21/00; H04N 5/232; H04N 5/357; H04N 5/44

(52) U.S. Cl. CPC G09B 21/008; H04N 5/44; H04N 5/23293; H04N 5/357; H04N 5/23212

(57) ABSTRACT

A wireless typoscope displays an enhanced image of an object to a person with poor vision. The wireless typoscope includes an image capture unit having (a) a camera for capturing an image of the object and (b) a wireless transmission unit, and a handheld image display unit having a touch screen. The image capture unit wirelessly transmits the image to the handheld image display unit which enhances and displays the image on the touch screen.

### RELATED APPLICATIONS

This application claims priority to U.S. Patent Application Ser. No. 61/983,670 titled “Wireless Typoscope”, filed Apr. 24, 2014, and incorporated herein by reference.

### BACKGROUND

A typoscope may be used to assist people with poor vision. A typoscope has a camera to capture an image of printed material and a monitor for displaying the captured image. The displayed image can be magnified optically or electronically, such that the person with poor vision can read it easily on the monitor. Other objects may also be viewed using the typoscope.

### SUMMARY OF THE INVENTION

An improved typoscope includes a camera or an image capture unit for capturing an image of printed material and any other object. The captured image is transmitted using wireless connection to a tablet or a handheld display unit. The tablet has touch screen interface for controlling the typoscope. The captured image is displayed on the touch screen display of the tablet. Since the tablet is independent from the image capture unit, a user may hold and view the tablet in any position.

In one embodiment, a wireless typoscope displays an enhanced image of an object. The wireless typoscope includes an image capture unit having (a) a camera for capturing an image of the object and (b) a wireless transmission unit, and a handheld image display unit having a touch screen. The image capture unit wirelessly transmits the image to the handheld image display unit which enhances and displays the image on the touch screen.

In another embodiment, a wireless image capture unit captures and transmits an image of an object to a handheld image display unit. The wireless image capture unit includes a camera for capturing the image, and a wireless transmission unit for transmitting the image wirelessly to the handheld image display unit. The wireless image capture unit is capable of being controlled from the handheld image display unit.

In another embodiment, an application (app) displays an enhanced image of an object and includes machine readable instructions for downloading to a tablet computer and storing in a memory of the tablet computer. The instructions, when executed by a processor of the tablet computer, make the tablet computer capable of: wirelessly receiving a captured image from an image capture unit, enhancing the captured image to generate the enhanced image with improved viewing by a person with poor vision, and displaying the enhanced image on a touch screen of the tablet computer.

### BRIEF DESCRIPTION OF THE FIGURES

FIG. 1 shows one exemplary wireless typoscope, in an embodiment.

FIG. 2 shows the handheld image display unit of FIG. 1 displaying enhanced buttons that allow the user to control enhancement of the captured image, in an embodiment.

### DETAILED DESCRIPTION OF THE EMBODIMENTS

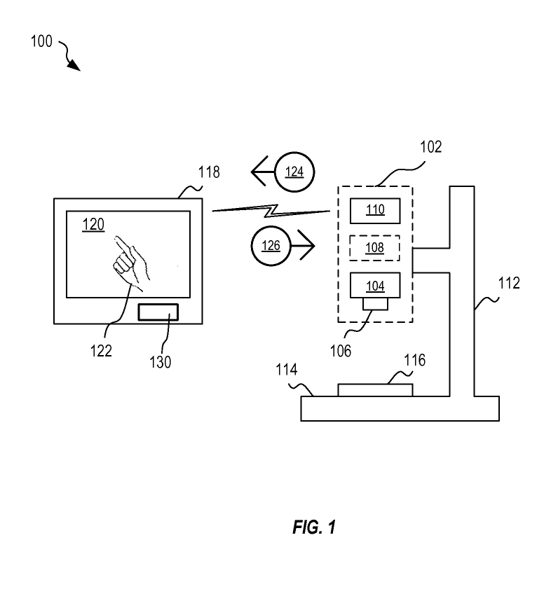

FIG. 1 shows one exemplary wireless typoscope 100. Wireless typoscope 100 includes an image capture unit 102 and a handheld image display unit 118, which are physically separated (i.e., not physically coupled together). Unlike conventional typoscope of the prior art, image capture unit 102 and handheld image display unit 118 are not enclosed in a common housing and are not physically integrated in the same system. Handheld image display unit 118 is for example a tablet computer (hereinafter referred to as a tablet). In the following description, an image may represent one or both of a still image and a video image.

Image capture unit 102 includes a camera 104 with a lens 106 and a transmission unit 110. Optionally, image capture unit 102 may also include an image compression unit 108, configured between camera 104 and transmission unit 110. Camera 104 may include an autofocus function. In one embodiment, image capture unit 102 includes a processor and memory that stores machine readable instructions that are executed by the processor to implement functionality of image capture unit 102.

Image capture unit 102 may be mounted to a supporting structure 112 that include a base 114, where camera 104 operates to capture an image of an object 116 disposed on base 114. Object 116 may be a printed material including a book, a magazine, a newspaper, and others. Object 116 may be an object having 3D structure as well.

In one example of operation, transmission unit 110 receives a captured image 124, optionally compressed by compression unit 108, from camera 104 and transmits image 124 wirelessly (e.g., via WiFi or Bluetooth protocols) to handheld image display unit 118. In one embodiment that includes compression unit 108, the captured image 124 is compressed by compression unit 108 prior to transmission of each image to handheld image display unit 118, thereby allowing system 100 to operate at a high resolution. Compression unit 108 may implement one or more of RGB, YUV, Motion-JPEG, H.264 and other formats. Although transmission unit 110 and handheld image display unit 118 may communicate using WiFi protocols, the WiFi network need not be connected to the Internet. In one example of operation, transmission unit 110 and handheld image display unit 118 form an ad hoc connection that enables communication therebetween.

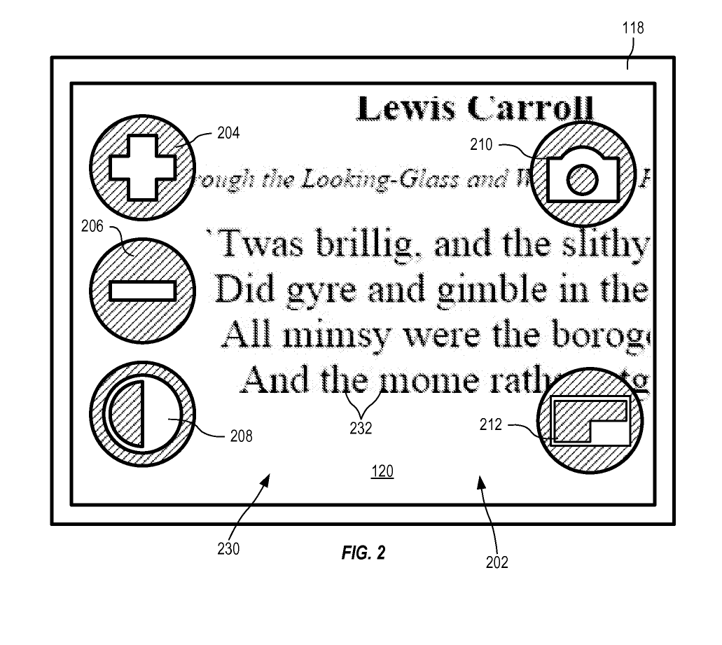

Handheld image display unit 118 includes a touch screen display 120, a processor, and memory, and wireless communication capability as found on commercially available tablet devices. The operations of handheld image display unit 118 and image capture unit 102 is controlled by a user's hand 122 touching touch screen display 120. For example, expanding two fingers on the touch screen may result in digital zooming of the viewed image on touch screen display 120. Handheld image display unit 118 may not have control buttons or knobs. In another example, the user may tap an area of touch screen display 120 to cause image capture unit 102 to focus camera 104 and/or lens 106 on a corresponding area of imaged object 116. For example, when the user taps touch screen display 120, app 130 sends a command to image capture unit 102 indicative of a position within captured image 124 corresponding to the tapped position on touch screen display 120 and enhanced image displayed thereon. In response, image capture unit 102 controls camera 104 and/or lens 106 to focus on a corresponding location of object 116. In one embodiment, a location of the enhanced image that is tapped by the user is also centered within touch screen display 120. Touch screen display 120 displays an overview of captured image 124, wherein selection of a location on the overview causes display of that portion of captured image 124 on touch screen display 120. In another embodiment, the user may select focus button 210 (see FIG. 2) to refocus the central location of object 116.

Handheld image display unit 118 may include at least one software application 130 that includes machine readable instructions that are executed by the processor of handheld image display unit 118 to implement functionality thereof. This functionality includes digital zooming, panning, image processing, and so on. The image processing may include captured image corrections such as lens correction and illumination correction, and special effects that enhance visibility for people with poor vision. These special effects may include enhanced contrast, converting color into black-and-white, edge enhancement to provide sharper image to improve the readability, and others. App 130 may enable handheld image display unit 118 to perform pattern or character recognition, and word to voice conversion. App 130 may include speech synthesis functionality that operates to generate speech indicative of operation of wireless typoscope 100. For example, app 130 may generate an audible message saying “wireless connection not established” when handheld image display unit 118 cannot connect wirelessly with image capture unit 102. In another example, app 130 may generate audible messages to instruct a partially sighted (low vision) user how to correct an identified problem.

FIG. 2 shows handheld image display unit 118 displaying enhanced buttons 204 through 212 that allow the user to control enhancement of image 124 for display as an enhanced image 202. Enhanced buttons 204 through 212 facilitate control by the user of image capture unit 102 and enhancement of captured image 124 for display on hand held image display unit 118 as enhanced image 202. The user may press and hold any one enhanced button 204 through 212 for a predetermined amount of time, such as two seconds, to cause app 130 to generate an audible message describing the functionality of that button.

Handheld image display unit 118 may wirelessly transmit (e.g., using WiFi and/or Bluetooth protocols) command signals 126 to image capture unit 102. The commands may include optical zooming, brightness, aperture, and shutter speed controls, and also resolution and frame rate selections. For example, resolution may be selected as one of 1280×720, 2688×1520, 3264×2448, or others. Frame rate may be 5 fps or others. In one embodiment, resolutions 1280×720, 2688×1520, and 3264×2448 may correspond to A4 paper sizes with resolutions 87 DPI, 184 DPI, and 279 dots per inch (DPI), respectively.

App 130 also allows the user to change either or both of the background color 230 and/or foreground color 232 to enhance readability. For example, by selecting enhanced button 208, the user controls app 130 to step through predefined color combinations of background 230 and foreground 232 thereby allowing the user to select the combination that is more viewable. In one embodiment, sixteen or more different color combinations may be selected.

In one embodiment, handheld display unit 118 does not utilize transmission functionality and image capture unit 102 may not include wireless receiving capability, such that all commands for image capture unit 102 are generated by image capture unit 102. In another embodiment, handheld display unit 118 and image capture unit 102 may be coupled by wire. For example, the wire may comprise a USB connection.

Handheld image display unit 118 and image capture unit 102 may have a built-in battery and may also have an external charger. The external charger may include a USB connector. Image capture unit 102 may include an illumination light source (e.g., an LED).

App 130 may include a training program (e.g., a tutorial) that runs on handheld image display unit 118 such that a user may self-train. The training may or may not use a real captured image. A user having poor vision may write on a paper, which is imaged by image capture unit 102 and displayed on touch screen 120 of handheld image display unit 118.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A wireless typoscope for displaying an enhanced image of an object, comprising:
an image capture unit having (a) a camera for capturing an image of the object and (b) a wireless transmission unit; and
a handheld image display unit having a touch screen;
wherein the image capture unit wirelessly transmits the image to the handheld image display unit, wherein the handheld image display unit enhances and displays the image on the touch screen.

2. The wireless typoscope of claim 1, further comprising an application (app) including machine readable instructions stored in a memory of the handheld image display unit and executed by a processor of the handheld image display unit to control one or both of capture and display of the image.

3. The wireless typoscope of claim 2, the app further including machine readable instructions for enhancing the image.

4. The wireless typoscope of claim 3, wherein the enhancing comprises special effects.

5. The wireless typoscope of claim 2, the app further including machine readable instructions for generating audio indication indicative of operation of the wireless typoscope.

6. The wireless typoscope of claim 5, the audio indication comprising voice synthesized messages.

7. The wireless typoscope of claim 1, further comprising an image compression unit for compressing the image before it is transmitted from the image capture unit.

8. The wireless typoscope of claim 1, the image capture unit being responsive to focus the camera on an area of the object corresponding to a location on the image indicated by a user touching the touch screen.

9. A wireless image capture unit for capturing and transmitting an image of an object to a handheld image display unit, comprising:
a camera for capturing the image; and
a wireless transmission unit for transmitting the image wirelessly to the handheld image display unit;
wherein the wireless image capture unit is capable of being controlled from the handheld image display unit.

10. The wireless image capture unit of claim 9, wherein the wireless transmission unit is capable of receiving commands from the handheld image display unit to adjust focus of the camera.

11. An application (app) for displaying an enhanced image of an object, comprising:
machine readable instructions for downloading to a tablet computer and storing in a memory of the tablet computer, wherein when executed by a processor of the tablet computer make the tablet computer capable of:
wirelessly receiving a captured image from an image capture unit;
enhancing the captured image to generate the enhanced image with improved viewing by a person with poor vision; and
displaying the enhanced image on a touch screen of the tablet computer.

12. The app of claim 11, further comprising machine readable instructions that when executed by the processor allow the person to adjust how the captured image is enhanced and displayed on the touch screen.

13. The app of claim 11, further comprising machine readable instructions that when executed by the processor display enhanced buttons on the touch screen, wherein the enhanced buttons are selectable by the person to control operation of (a) the enhancing of the captured image, and (b) control operation of the image capture unit.

14. The app of claim 11, further comprising machine readable instructions that when executed by the processor generate synthesized voice messages to facilitate operation of at least one of the app and the image capture unit.
